(19) United States
(12) Patent Application Publication
(10) Pub. No.: US 2026/0307067 A1
(43) Pub. Date: Oct. 8, 2026

(54) OXYGEN REDUCTION CATALYST AND USE THEREOF

(71) Applicant: TOYOTA JIDOSHA KABUSHIKI KAISHA, Toyota-shi (JP)

(72) Inventor: Keiichi OKUBO, Toyota-shi (JP)

(73) Assignee: TOYOTA JIDOSHA KABUSHIKI KAISHA, Toyota-shi (JP)

(21) Appl. No.: 19/437,582

(22) Filed: Dec. 31, 2025

(30) Foreign Application Priority Data
Apr. 4, 2025 (JP) 2025-062734

(51) Int. Cl. B01J 31/02; B01J 23/42; B01J 31/06; C25B 1/04; C25B 11/054; C25B 11/055; C25B 11/081; H01M 4/86; H01M 4/92

(52) U.S. Cl. CPC B01J 31/0244; B01J 23/42; B01J 31/06; C25B 1/04; C25B 11/054; C25B 11/055; C25B 11/081; H01M 4/925; H01M 2004/8689

(57) ABSTRACT

An oxygen reduction catalyst may include a catalyst metal having oxygen reduction reaction activity, and a modified layer including one or more organic nitrogen compounds and a radical quencher. The one or more organic nitrogen compounds may be selected from the group consisting of nitrogen-containing organic compounds having a triazine ring, polymers containing a portion thereof, and cations thereof. The radical quencher may include one or more structural moieties selected from the group consisting of a hydroxyphenyl triazine skeleton and a hindered amine skeleton.

### CROSS REFERENCE TO RELATED APPLICATION

This application claims priority to Japanese Patent Application No. 2025-062734 filed on Apr. 4, 2025. The entire content of the priority application is incorporated herein by reference.

### TECHNICAL FIELD

The art disclosed herein relates to an oxygen reduction catalyst and use thereof.

### BACKGROUND ART

Organic nitrogen compounds that are added to catalyst metals used in fuel cells and metal-air batteries are known to enhance the activity of oxygen reduction reactions in the catalysts, thereby improving the power generation efficiency of the fuel cells. Examples of such organic nitrogen compounds include, for example, melamine-formaldehyde polymers obtained by polymerizing monomers containing aldehyde groups (JP 2024-11754A).

### SUMMARY

However, hydrogen peroxide is generated in a catalyst layer containing an organic nitrogen compound such as melamine-formaldehyde polymer. It has been found that hydrogen peroxide can be converted into radicals by coexisting Fe ions and these radicals may decompose the organic nitrogen compound in the catalyst layer.

The disclosure herein provides a technology that contributes to improving the radical durability of an organic nitrogen compound added to an oxygen reduction catalyst.

The disclosure herein relates to an oxygen reduction catalyst. The oxygen reduction catalyst may comprise a catalyst metal having oxygen reduction reaction activity, and a modified layer comprising one or more organic nitrogen compounds and a radical quencher. The one or more organic nitrogen compounds may be selected from the group consisting of nitrogen-containing organic compounds having a triazine ring, polymers containing a portion thereof, and cations thereof. The radical quencher may comprise one or more structural moieties selected from the group consisting of a hydroxyphenyl triazine skeleton and a hindered amine skeleton.

According to this oxygen reduction catalyst, the modified layer contains the organic nitrogen compound(s) and the radical quencher. The radical quencher coexists with the organic nitrogen compound(s) in the modified layer and is retained in the modified layer regardless of fuel cell operation. Therefore, even if hydrogen peroxide radicals are generated in the modified layer, they are stably captured. Thus, decomposition of the organic nitrogen compound(s) is avoided or suppressed. Consequently, a decrease in the efficiency of oxygen reduction reaction is avoided or suppressed.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved oxygen reduction catalysts and uses thereof.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### DETAILED DESCRIPTION

The oxygen reduction catalyst disclosed herein can further include the following aspects. In another aspect of the oxygen reduction catalyst, the radical quencher may comprise the hydroxyphenyl triazine skeleton and the hindered amine skeleton. This contributes to maintaining the power generation efficiency of a fuel cell.

In another aspect of the oxygen reduction catalyst, the hindered amine skeleton may have a hydroxy group or an alkoxy group that contains an alkyl group having 1 to 12 carbon atoms or a cycloalkyl group having 1 to 12 carbon atoms. The hydroxy group or the alkoxy group may be bonded to a nitrogen atom on the hindered amine skeleton. This further contributes to maintaining the power generation efficiency of a fuel cell.

Disclosed herein are also a cathode for a fuel cell comprising the above-described oxygen reduction catalyst and a fuel cell comprising this cathode. Further, disclosed herein are also an anode for a water electrolysis system comprising the above-described oxygen reduction catalyst and a water electrolysis system comprising this anode.

Hereinafter, various embodiments of the oxygen reduction catalyst (which may be simply referred to as “catalyst”) disclosed herein are described in detail.

The oxygen reduction catalyst disclosed herein may be used for fuel cells or for metal-air batteries. The catalyst disclosed herein may be used for a cathode of a fuel cell, for an anode of a fuel cell, or for an air electrode of a metal-air battery. Furthermore, the catalyst disclosed herein may be used for an anode for water electrolysis, which is the reverse reaction in fuel cells, for a cathode for water electrolysis, for an anode for CO₂ reduction, or for a cathode for CO₂ reduction.

The oxygen reduction catalyst disclosed herein may, for example, be in the form of a catalyst ink or in a layered form. A binder (which will be described below) may be used as needed.

### (Oxygen Reduction Catalyst)

The oxygen reduction catalyst disclosed herein comprises a catalyst metal and a modified layer containing an organic nitrogen compound and a radical quencher.

### (Catalyst Metal)

The catalyst metal contained in the catalyst is not particularly limited as long as it has oxygen reduction activity. Examples of the catalyst metal include metals such as platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and the catalyst metal may be a combination of two or more of these metals. Additionally, the metals may be oxides, nitrides, sulfides, or phosphides.

The catalyst metal may preferably be one or more selected from platinum, platinum alloys, and platinum-containing complexes. Examples of the metals other than platinum contained in the platinum alloys and the platinum-containing complexes include ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and the metals may comprise two or more of these metals. The atomic percentages of the metals other than platinum in the platinum alloys are not particularly limited and may be 0.11 to 50 at %.

The catalyst metal is typically in the form of metal particles. The average particle size (particle diameter) is not specifically limited and may be, for example, 1 nm or more and 100 nm or less.

The catalyst metal may be supported on a carrier. Examples of the carrier include carbon and oxides. The carrier may be, for example, conductive carbon, an oxide, or a mixture containing at least two of these. Examples of the carbon include carbon black (acetylene black, Ketjen black, channel black, roller black, disk black, oil furnace black, gas furnace black, lamp black, thermal black, and VULCAN (registered trademark) carbon, etc.), activated carbon, black lead, glassy carbon, graphite, graphene, carbon fibers, carbon nanotubes, carbon nitrides, carbon sulfides, carbon phosphides, and mixtures containing at least two of these. Examples of the oxide include titanium oxides, niobium oxides, tin oxides, tungsten oxides, molybdenum oxides, and mixtures containing at least two of these.

The carrier may be either primary particles or secondary particles. The average particle size of the primary particles is not particularly limited and may be, for example, 5 nm or more and 500 nm or less.

(Modifying Layer) The modified layer is provided on the surface of the catalyst metal to accelerate the oxygen reduction activity of the catalyst metal. The modified layer contains an organic nitrogen compound(s) and a radical quencher.

### (Organic Nitrogen Compound(s))

The organic nitrogen compound(s) contained in the catalyst are not particularly limited as long as they have oxygen reduction activity by the catalyst metal. Examples of such organic nitrogen compound(s) include organic nitrogen compounds having a triazine ring as a basic functional group, polymers containing a portion thereof, and cations thereof. The cation includes a cation formed by dissociating a basic functional group contained in an organic nitrogen compound, or a cation that forms a salt with an organic acid or an inorganic acid.

For example, a triazine skeleton may have a structure illustrated below.

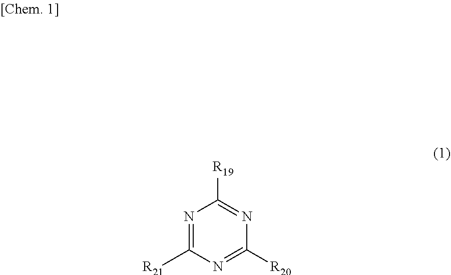

In the formula (1), each of R₁₉, R₂₀, and R₂₁ is a hydrogen atom, a halogen atom, or one functional group selected from the group consisting of: nitrile groups, amide groups, imine groups, amino groups, thiol groups, hydroxyl groups, sulfo groups, carboxylic acid groups, phosphate groups, ketone groups, aldehyde groups, ester groups, alkoxy groups, phenol groups, cyclopentyl groups, cyclohexyl groups, alkylamino groups having 1 to 10 carbon atoms, alkylsulfonic acid groups having 1 to 10 carbon atoms, perfluoroalkyl groups having 1 to 10 carbon atoms, alkyl groups having 1 to 10 carbon atoms, alkenylamino groups having 1 to 10 carbon atoms, alkenylsulfonic acid groups having 1 to 10 carbon atoms, perfluoroalkenyl groups having 1 to 10 carbon atoms, and alkenyl groups having 1 to 10 carbon atoms. The functional group may, on the molecular chain, have at least one member selected from the group consisting of: at least one functional group selected from the above-listed functional groups, an aromatic ring, a heterocycle, an oxygen atom, a sulfur atom, a nitrogen atom, a fluorine atom, a chlorine atom, a bromine atom, an iodine atom, and a hydrogen atom.

In the formula (1), each of R₁₉, R₂₀, and R₂₁ may be a primary amine, a secondary amine, a tertiary amine, or a quaternary ammonium cation.

The organic nitrogen compound(s) may include, for example, melamine compound(s). Examples of the melamine compound(s) include melamine and melamine derivatives. Furthermore, the organic nitrogen compound(s) may include thiocyanuric acid compound(s). Examples of the thiocyanuric acid compound(s) include thiocyanuric acids and thiocyanuric acid derivatives. Examples of cyanuric acid compounds include cyanuric acids and cyanuric acid derivatives. Examples of polymers containing melamine compounds, thiocyanuric acid compounds, or cyanuric acid compounds as monomers include melamine resins, thiocyanuric acid resins, and cyanuric acid resins that have the aforementioned melamine compounds, thiocyanuric acid compounds, or cyanuric acid compounds as repeating units in their main chains.

More specifically, examples of the organic nitrogen compound(s) include melamine compounds (nitrogen equivalent 21 g·eq⁻¹), thiocyanuric acid compounds (nitrogen equivalent 59 g·eq⁻¹), cyanuric acid compounds (nitrogen equivalent 34 g·eq⁻¹), 2,4,6-Tris[bis(methoxymethyl)amino]-1,3,5-triazine (nitrogen equivalent 65 g·eq⁻¹), 6-(Dibutylamino)-1,3,5-triazine-2,4-dithiol (nitrogen equivalent 68 g·eq⁻¹), 2,4-Diamino-6-butylamino-1,3,5-triazine (nitrogen equivalent 30 g·eq⁻¹), 2,4,6-Tris(pentafluoroethyl)-1,3,5-triazine (nitrogen equivalent 145 g·eq⁻¹), and polymers containing these as monomers, as well as Poly(melamine-co-formaldehyde) methylate (nitrogen equivalent 20 to 40 g·eq⁻¹) and Poly(melamine-co-formaldehyde) isobutylated (nitrogen equivalent 20 to 40 g·eq⁻¹).

The organic nitrogen compound(s) may include oleylamine (nitrogen equivalent 267 g·eq⁻¹) and/or tetradecylamine (nitrogen equivalent 213 g·eq⁻¹).

Among the above, the organic nitrogen compound(s) may be preferably melamine (1,3,5-triazine-2,4,6-triamine) or a polymer thereof. In the case of polymer, adsorption stability is improved because desorption is less likely to occur after adsorption to metal particles, compared to monomers. The polymer may have a degree of polymerization in the range of 1 to 10,000.

The organic nitrogen compound(s) may satisfy a nitrogen equivalent of 20 to 270 g·eq⁻¹ which represents the dry weight per mole of nitrogen, or a nitrogen equivalent of 20 to 270 g·eq⁻¹. The nitrogen equivalent can be calculated using the formula below. For polymers, the nitrogen equivalent of the monomers is considered to be the nitrogen equivalent of the polymer.

$$Nitrogen equivalent ( g \cdot {eq}^{- 1} ) = molecular weight ( g / mol ) \div amount of nitrogen in the molecule ( {mol}_{N} / mol )$$

The content of the organic nitrogen compound(s) in the catalyst is not particularly limited. For example, the content of the organic nitrogen compound(s) relative to the mass of the catalyst metal carrier alone can be 1.0 mass % or more and 15 mass % or less.

Here, the mass of the organic nitrogen compound(s) is measured by extracting the organic nitrogen compound(s) from the catalyst and using chromatography such as HPLC or GC. The mass of the carrier can be measured using the following method. First, organic compounds such as the organic nitrogen compound(s), radical quencher, and binder are removed from the catalyst by solvent separation, and then the carrier supporting the remaining catalyst metal is obtained. The catalyst metal carrier is then calcined to remove the carrier (the resulting residue is the catalyst metal) to measure the mass. Furthermore, for identification of the organic nitrogen compound(s) and the carrier, an appropriate method such as mass spectrometry, NMR, IR, or UV can be used.

### (Radical Quencher)

The radical quencher can include one or more structural moieties selected from the group consisting of: a hydroxyphenyl triazine skeleton and a hindered amine skeleton. By using the radical quencher comprising one or more of the skeletons as structural moieties, the radical quencher coexists with the organic nitrogen compound(s) in the modified layer, thereby avoiding or suppressing a decrease in the radical durability of the organic nitrogen compound(s).

An example of the radical quencher having a hydroxyphenyl triazine skeleton includes a compound represented by the formula (I) below. The presence of a hydroxyphenyl triazine skeleton, i.e., the presence of a triazine skeleton, enhances compatibility with the organic nitrogen compound(s) and facilitates oxygen reduction reactions by the catalyst metal.

For example, at least one of R₁ to R₁₅ in the compound may preferably comprise a hydroxy group. The presence of a hydroxy group may enhance compatibility with the organic nitrogen compound(s). For example, the hydroxy moiety may be, for example, the ortho position relative to the linkage position to the triazine skeleton. Each of R₁ to R₁₅ represents independent functional groups, however, since this type of radical quencher is highly diverse, the specific types of functional groups are not particularly limited. For example, the compound may have a hydroxyl group or an alkyl group having 1 to 4 carbon atoms such as a methyl group at the ortho position relative to the linkage position of the phenyl group. Furthermore, the compound may have a cycloalkyl group or phenyl group having 1 to 15 carbon atoms, an alkyl group having 1 to 15 carbon atoms, and/or a hydroxy group that can be substituted with an alkylene glycol alkyl ether having 1 to 10 carbon atoms at the para position relative to the linkage position of the phenyl group.

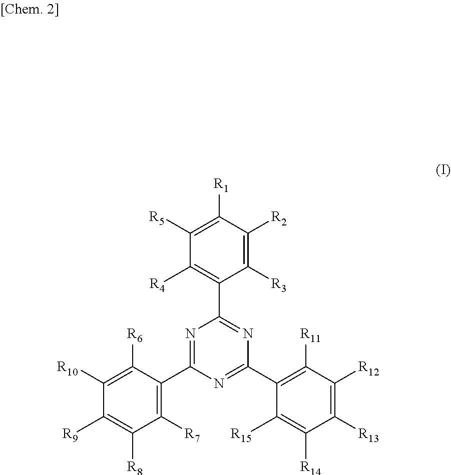

This type of radical quencher is commercially available, for example, as a so-called triazine-based light stabilizer (UV absorber). Examples of the triazine-based radical quencher include Tinuvin (a registered trademark of BASF Corporation) 400, Tinuvin 405, Tinuvin 477, Tinuvin 479, Tinuvin 1600 (all manufactured by BASF Corporation), D4527 (2-(2,4-Dihydroxyphenyl)-4,6-bis(2,4-dimethylphenyl)-1,3,5-triazine), D4819 (2-(2,4-Dihydroxyphenyl)-4,6-diphenyl-1,3,5-triazine), E1312 (Ethylhexyl Triazone), H1531 (2-(2-Hydroxy-4-methoxyphenyl)-4,6-diphenyl-1,3,5-triazine), T3240 (N,N′,N″-Tri(m-tolyl)-1,3,5-triazine-2,4,6-triamine), T3869 (2,4,6-Tris(2,4-dihydroxyphenyl)-1,3,5-triazine), T3870 (2,4,6-Tris(4-butoxy-2-hydroxyphenyl)-1,3,5-triazine), B4399 (2,4-Bis(2,4-dimethylphenyl)-6-(2-hydroxy-4-n-octyloxyphenyl)-1,3,5-triazine), B6145 (Bemotrizinol), and B6601 (2-[4,6-Bis(2,4-dimethylphenyl)-1,3,5-triazin-2-yl]-5-[3-[(2-ethylhexyl)oxy]-2-hydroxypropoxy]phenol) (all manufactured by Tokyo Chemical Industry Co., Ltd. (TCI)).

An example of the radical quencher having a hindered amine skeleton includes a compound represented by the following formula (II). Each of R₁₆ to R₁₈ is independently a hydrogen atom, an alkyl group of cycloalkyl having 1 to 12 carbon atoms, an alkoxy group of an alkyl or cycloalkyl group having 1 to 12 carbon atoms. For example, it may be preferable that each of R₁₆ and R₁₇ is a hydrogen atom, a carbonyloxy group having an alkyl or alkenyl group having 1 to 12 carbon atoms, and R₁₈ is preferably an alkyl group having 1 to 12 carbon atoms, a cycloalkyl group having 1 to 12 carbon atoms, an alkoxy group having an alkyl or cycloalkyl group with 1 to 12 carbon atoms, or a hydroxy group. When R₁₈ is one of these substituents, the radical quencher can maintain its ability to promote the catalytic reaction of the catalyst metal in the modified layer. In particular, a hydroxy group or alkoxy group linked to a nitrogen atom on a hindered amine skeleton may promote the catalytic reaction. The hydrogen atoms of the alkyl group, cycloalkyl group, and various alkyloxy groups of R₁₈ may be substituted with halogen atoms, hydroxyl groups, aldehyde groups, or carboxyl groups.

R₁₆ to R₁₈ may be such that two hindered amine skeleton-containing compounds are linked via one substituent to form a radical quencher having two hindered amine skeletons. For example, the radical quencher may have two hindered amine skeletons connected via a triazine skeleton through one of R₁₆ and R₁₇. The presence of a triazine skeleton improves compatibility with the organic nitrogen compound(s), facilitates coexistence of the radical quencher in the modified layer, and promotes oxygen reduction reactions by the catalyst metal. In this case, it is further preferable that R₁₈ is an alkoxy group having a cycloalkyl group with 1 to 12 carbon atoms such as a cyclohexyl group, an alkoxy group having an alkyl group with 1 to 12 carbon atoms, or a hydroxy group.

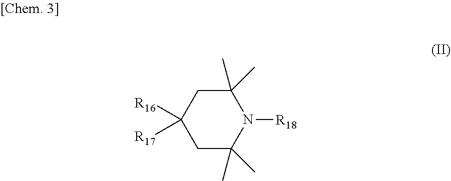

Examples of this type of radical quencher include Tinuvin 123 (Decanedioic acid, bis(2,2,6,6-tetramethyl-1-(octyloxy)-4-piperidinyl)ester, reaction products with 1,1-dimethylethylhydroperoxide and octane), Tinuvin 152, Tinuvin 144 (Bis(1,2,2,6,6-pentamethyl-4-piperidinyl)-[[3,5-bis(1,1-dimethylethyl)-4-hydroxyphenyl]methyl]butylmalonate), Tinuvin 292 (Bis(1,2,2,6,6-pentamethyl-4-piperidinyl) sebacate Methy (1 1,2,2,6,6-pentamethyl-4-piperidinyl) sebacate), Tinuvin 770DF (Bis(2,2,6,6-tetramethyl-4-piperidyl) sebacate) (all manufactured by BASF Corporation), and B5642 (Bis(2,2,6,6-tetramethyl-4-piperidyl-1-oxyl) sebacate), B6267 (Bis(1,2,2,6,6-pentamethyl-4-piperidyl) butyl(3,5-di-tert-butyl-4-hydroxybenzyl)malonate), S0448 (Bis(2,2,6,6-tetramethyl-4-piperidyl) sebacate), T2324 (2,2,6,6-Tetramethyl-4-piperidyl Methacrylate), P1513 (1,2,2,6,6-Pentamethyl-4-piperidyl Methacrylate (stabilized with MEHQ)), B6154 (N¹,N³-bis(2,2,6,6-tetramethylpiperidin-4-yl)isophthalamide) (all manufactured by TCI Co., Ltd.).

The radical quencher with a hindered amine skeleton may preferably have a pKb of 7.0 or greater. Such basicity may enhance retention in the modified layer.

The structural formulas of Tinuvin 400, Tinuvin 405, and Tinuvin 152 among the above examples are as below.

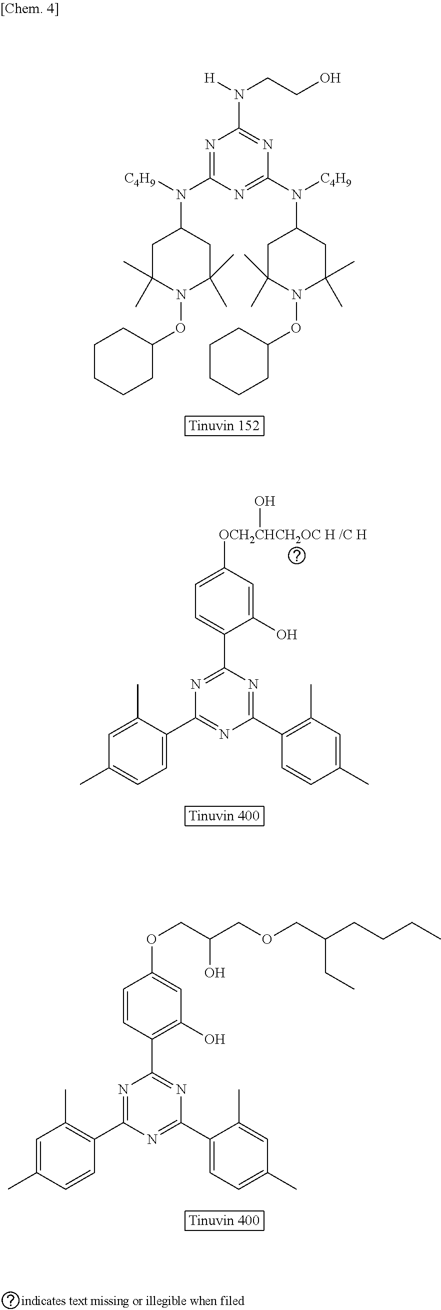

The content of the radical quencher is not particularly limited as long as it can avoid or suppress decomposition by radicals of the organic nitrogen compound(s). For example, the amount of radical quencher may be the same as the mass of the organic nitrogen compound(s). For example, the amount of the radical quencher may be 70% or more and 130% or less, 80% or more and 120% or less, or 90% or more and 110% or less relative to the content of the organic nitrogen compound(s) (mass %) relative to the mass of the carrier. The mass of the radical quencher is measured by extracting the radical quencher from the catalyst and using chromatography such as HPLC or GC. The mass of the carrier can be measured using the following method. First, organic compounds such as the organic nitrogen compound(s) and binder are removed from the catalyst by solvent separation, and then the carrier supporting the remaining catalyst metal is obtained. The catalyst metal carrier is then calcined to remove the carrier, and the mass of the carrier can be measured from the residue. For identification of the quencher, an appropriate method such as mass spectrometry, NMR, IR, or UV can be used.

### (Binder)

The catalyst can further include a binder. The binder is a polymer electrolyte containing an ion exchange group such as an acidic functional group or a basic functional group. The polymer electrolyte may be referred to as an electrolyte or ionomer. Examples of the acidic functional group include sulfonic acids and phosphoric acids. Examples of the basic functional group include quaternary ammonium cations. The binder may be a perfluorocarbon sulfonic acid polymer, an anion exchange polymer, or a polymer primarily composed of polyether ether ketone or polybenzimidazole.

The content of the binder in the catalyst is not particularly limited as long as it can form the modified layer on the catalyst metal. For example, the ratio of the binder's mass to the carrier's mass can be 70 mass % or more and 115 mass % or less. The mass of the carrier has already been described. The mass of the binder is measured by extracting the binder from the catalyst. For identification of the binder, an appropriate method such as mass spectrometry, NMR, IR, or UV can be used.

As described above, the catalyst can be in the form of a catalyst ink, and after application of the catalyst ink, it can be in the form of a catalyst layer. Hereinafter, formation of a catalyst ink and a catalyst layer is described.

### (Preparation of Catalyst Ink)

First, predetermined amounts of a catalyst metal carrier (carrier supporting a catalyst metal), organic nitrogen compound(s), a radical quencher, a binder, and a solvent are added to a container, and they are stirred by a stirrer to prepare a catalyst ink. The type of solvent is not particularly limited and any liquid can be used. Examples of the solvent include alcohols and mixtures of at least one alcohol and water. Examples of the alcohols include methanol, diacetone alcohol, ethanol, 1-propanol, 2-propanol, tert-butyl alcohol, ethylene glycol, and propylene glycol.

The stirrer is not particularly limited and any known stirrer can be used. Examples of the stirrer include ultrasonic homogenizers, jet mills, ball mills such as bead mills, high-shear mixers, and philmix. Stirring conditions such as stirring speed, stirring time, and rotation speed are not particularly limited and may be set as appropriate.

After stirring, vacuum degassing is performed, and the container is left to stand for one day. The standing time is not particularly limited and may be set as desired. Alternatively, the container may not be left to stand. Furthermore, the vacuum degassing may be performed again.

### (Formation of Catalyst Layer)

The prepared catalyst ink is applied onto a predetermined substrate, and the solvent is removed after the application. For example, the catalyst ink is applied onto the substrate, and the applied catalyst ink is heated to dry and remove the solvent.

The substrate is not particularly limited and examples of the substrate include polytetrafluoroethylene (PTFE), electrolyte membranes having ion exchange groups, gas diffusion layers (GDLs) composed of carbon fibers and/or metal fibers, and gas diffusion layers composed of carbon fibers and/or metal fibers having microporous layers (MPLs).

The method of applying the catalyst ink onto the substrate may be any method as long as it can uniformly apply the catalyst ink onto the substrate, and the method may be die coating, spin coating, screen printing, doctor blade coating, squeegee coating, spray coating, or applicator coating. The heating rate and heating time may be appropriately set depending on the type of solvent. Additionally, the removal rate may be increased by degassing simultaneously with heating. The layer thickness may be 5 to 30 μm, and the catalyst ink may be applied such that the platinum content satisfies 0.1 to 0.6 mg·cm⁻².

### (Catalyst Layer)

According to the disclosure herein, an oxygen reduction catalyst layer or an oxygen generation catalyst layer containing the above-described catalyst is provided. Since the oxygen reduction reaction of the catalyst metal is reversible, a fuel cell comprising this catalyst layer as a cathode (oxygen reduction catalyst layer) is also provided. The fuel cell may be, for example, a PEFC. In such a fuel cell, a decrease in the power generation efficiency of the fuel cell due to radical generation is avoided or suppressed.

Furthermore, a water electrolysis device comprising a catalyst layer containing the above-described catalyst as an anode (oxygen evolution reaction catalyst layer) is also provided. In such a water electrolysis device, a decrease in the water generation efficiency of the water electrolysis device due to radical generation is avoided or suppressed.

### EXAMPLES

Hereinafter, examples of the disclosure herein are described. These examples are provided to illustrate the disclosure herein and are not intended to limit the scope of the disclosure.

### Example 1

Predetermined amounts of a carrier (acetylene black) supporting platinum particles (particle size: 3 to 4 nm) as a catalyst thereon (catalyst metal particle carrier), organic nitrogen compound(s) (melamine resin), a radical quencher, a binder (perfluorocarbon sulfonic acid), and a solvent (mixture of water and alcohol), which are listed in the table below, were put into a container. The mass of the organic nitrogen compound(s) relative to the mass of the carrier was 3 mass %, and the mass of the radical quencher was 3 mass %. These materials were mixed and stirred by a stirrer (homogenizer, philmix) to prepare catalyst inks of Examples 1 to 4 containing an oxygen reduction catalyst. A catalyst ink of Comparative Example 1 was prepared in the same manner as Examples 1, etc. except for the omission of the radical quencher. Furthermore, a catalyst ink of Comparative Example 2 was prepared in the same manner as Example 1 except for the omission of the organic nitrogen compound(s) and the radical quencher.

TABLE 1

| | | Type of radical quencher, etc. | | | | | | Cell voltage | |
|---|---|---|---|---|---|---|---|---|---|
| | | | | | | | Mass ratio | after 72 | |
| | | | | Substituent | | Mass Ratio | of organic | hours of | Cell |
| | | | | bonded to N | | of Radical | nitrogen | endurance | Voltage |
| | | | Triazine | of hindered | | Quencher | compounds | testing at | retention |
| Sample Type | | Type | skeleton | amine skeleton | Type of R | to Carrier | to carrier | 0.05 A/cm² | rate (%) |
| Examples | 1 | Hindered amine | Contained | OR | Cycloalkyl | 0.03 | 0.03 | 0.731 | 94 |
| | 2 | Same as above | Not contained | OR | Alkyl | 0.03 | 0.03 | 0.727 | 90 |
| | 3 | Same as above | Not contained | R | Methyl | 0.03 | 0.03 | 0.709 | 87 |
| | 4 | Hydroxyphenyl | Contained | — | — | 0.03 | 0.03 | 0.720 | 86 |
| | | triazine | | | | | | | |
| Comparative | 1 | None | — | — | — | 0 | 0.03 | 0.691 | 83 |
| Example | 2 | None | — | — | — | 0 | 0 | 0.668 | 80 |

The radical quenchers used in Examples 1 to 4 had the characteristics below in addition to those shown in Table 1.
Example 1: Two hindered amine skeletons are linked to carbon atoms of one hydroxyphenyl triazine skeleton.
Example 2: Two hindered amine skeletons are linked to each other.
Example 3: Two hindered amine skeletons are linked to each other.
Example 4: There are two hydroxy groups.

After degassed appropriately, each catalyst ink was applied onto a substrate and the catalyst ions were heated after the application to remove the solvent, thereby forming a catalyst layer.

Then, the formed catalyst layers were used as cathode catalyst layers, perfluorocarbon sulfonic acid polymer (Chemours Nafion NR211, EW: 1100) was used as electrolyte membranes, and platinum-supported carbon catalyst (Tanaka Precious Metal Technologies Co., Ltd., TEC10E50E) was used as anode catalyst layers. Each electrolyte membrane was sandwiched between a cathode catalyst layer and an anode catalyst layer. Under the heat (130° C.) and pressure (3 MPa), the cathode catalyst layer, the electrolyte membrane, and the anode catalyst layer were thermally bonded. Gas diffusion layers (SGL Corporation, 22BB) made of carbon fibers were placed on the outer sides of the cathode catalyst layer and the anode catalyst layer to make a membrane electrode assembly (MEA) (electrode portion: 1 cm×1 cm).

Then, the MEAs were used as single cells to measure current-voltage characteristics under low humidity condition (30% RH) and high humidity condition (80% RH). The measurement conditions were as follows: sweep rate: 20 mA/s (anode sweep), cell temperature: 80° C., pressure: 150 kPa_ABS, cathode gas: air, cathode gas flow rate: 2.0 L/min.

(Evaluation of Radical Quenching Performance) Membrane electrode assembly containing 2 g of Fe ions were maintained at 95° C., 40% RH, and 0.05 A/cm² for 72 hours. This prepared a system where hydrogen peroxide generated within a system was converted into radicals by the Fe ions. Subsequently, current-voltage characteristics were evaluated under the same conditions as above, and the cell voltage retention rates were calculated. The results are shown in Table 1.

As shown in Table 1, Example 1, which used a radical quencher that has a hindered amine skeleton with an alkoxy group having a cycloalkyl group as OR and further has a triazine skeleton internally, exhibited the highest cell voltage retention rate (94%). Next, Example 2, which used a radical quencher that has a hindered amine skeleton with an alkoxy group having an alkyl group as OR but does not have a triazine skeleton internally, showed the next highest retention rate (90%). Example 3, which used a radical quencher that has a hindered amine skeleton with a methyl group as R but does not have a triazine skeleton internally, showed the third highest retention rate (87%).

From the above, it has been found that radical quenchers having a hindered amine skeleton may preferably have a triazine skeleton for radical quenching performance. Furthermore, it has been also found that having various alkoxy groups linked to N of the hindered amine is more preferable for radical quenching performance than having alkyl groups, and that the alkoxy group of cycloalkyl group is more preferable for radical quenching performance than the alkoxy group of alkyl group.

It has been also found that radical quenchers having a hydroxyphenyl triazine skeleton can exhibit radical quenching performance due to the inherent presence of the triazine skeleton.

The results of Comparative Examples 1 and 2 indicate that the inclusion of organic nitrogen compound(s) is useful and the presence of radical quencher significantly contributes to maintaining the oxygen reduction reaction-promoting activity of the catalyst metal of organic nitrogen compound(s).

What is claimed is:

1. An oxygen reduction catalyst comprising:
a catalyst metal having oxygen reduction reaction activity, and
a modified layer comprising one or more organic nitrogen compounds and a radical quencher,
wherein the one or more organic nitrogen compounds are selected from the group consisting of nitrogen-containing organic compounds having a triazine ring, polymers containing a portion thereof, and cations thereof, and
wherein the radical quencher comprises one or more structural moieties selected from the group consisting of a hydroxyphenyl triazine skeleton and a hindered amine skeleton.

2. The oxygen reduction catalyst according to claim 1, wherein the radical quencher comprises the hydroxyphenyl triazine skeleton and the hindered amine skeleton.

3. The oxygen reduction catalyst according to claim 1, wherein the radical quencher comprises the hindered amine skeleton having a hydroxy group or an alkoxy group that contains an alkyl group having 1 to 12 carbon atoms or a cycloalkyl group having 1 to 12 carbon atoms, wherein the hydroxy group or the alkoxy group is bonded to a nitrogen atom on the hindered amine skeleton.

4. A cathode for a fuel cell comprising the oxygen reduction catalyst according to claim 1.

5. A fuel cell comprising the cathode according to claim 4.

6. An anode for a water electrolysis system comprising the oxygen reduction catalyst according to claim 1.

7. A water electrolysis system comprising the anode according to claim 6.
